(19) United States
(12) Patent Application Publication
(10) Pub. No.: US 2012/0172010 A1
(43) Pub. Date: Jul. 5, 2012

(54) MEDIUM RANGE VEHICLE COMMUNICATION SYSTEM

(75) Inventors: TODD P. OMAN, GREENTOWN, IN (US); XINHUA (SAM) HE, ZIONSVILLE, IN (US)

(73) Assignee: DELPHI TECHNOLOGIES, INC., TROY, MI (US)

(21) Appl. No.: 12/981,876

(22) Filed: Dec. 30, 2010

(51) Int. Cl. H04W 4/04

(52) U.S. Cl. 455/414.1

(57) ABSTRACT

A communication system for communicating with a vehicle via a wireless personal communication device such as a smart phone. The communication system uses medium-range transceivers to extend the effective range of the communication system. A communication device accessory that includes a portable medium-range RF transceiver is coupled to the wireless personal communication device so that power for the portable medium-range RF transceiver can be drawn from the wireless personal communication device. The communication device accessory is electrically coupled to the wireless personal communication device via a wired connection that provides at least a wired electrical power connection and optionally a wired data connection between the communication device accessory and the wireless personal communication device.

### TECHNICAL FIELD OF INVENTION

The invention generally relates to a communication system for communicating with a vehicle, and more particularly relates to a wireless personal communication device accessory configured to enable communications between a wireless personal communication device such as a smart phone and an in-vehicle telematics unit electrically coupled to the vehicle electrical system.

### BACKGROUND OF INVENTION

Many vehicles are equipped with remote keyless entry (RKE) systems configured to operate vehicle devices such as a vehicle-door lock/unlock system or a remote vehicle engine starting system. Such RKE systems typically use a key fob equipped with a low-power, short-range radio-frequency (RF) transmitter activated by an operator of the vehicle pressing a button on the key fob. In general, the power transmitted by the RF transmitter is intentionally limited in order to prolong battery life, and so most RKE systems have limited effective ranges, less than thirty (30) meters for example. Increasing transmit power in order to increase the effective range requires larger batteries to extend battery life, or requires frequent changing or recharging of the key fob batteries. Larger batteries undesirably increases key fob size and weight, and frequent changing or charging is inconvenient and increases the risk of the key fob being inoperative due to discharged batteries.

### SUMMARY OF THE INVENTION

In accordance with one embodiment of this invention, a communication system for communicating with a vehicle is provided. The system includes an in-vehicle telematics unit, a wireless personal communication device, and a communication device accessory. The in-vehicle telematics unit is configured to determine vehicle data and control operation of a vehicle device. The in-vehicle telematics unit is equipped with an in-vehicle medium-range RF transceiver. The wireless personal communication device is carried by an operator of the vehicle. The communication device accessory is detachably coupled and electrically connected to the wireless personal communication device in a manner effective to receive electrical power from the wireless personal communication device. The communication device accessory is equipped with a portable medium-range RF transceiver configured to communicate directly with the in-vehicle medium-range RF transceiver such that the wireless personal communication device can communicate directly with the in-vehicle telematics unit in a manner effective for the wireless personal communication device to display the vehicle data and control operation of the vehicle device.

In another embodiment of the present invention, a wireless personal communication device accessory is provided. The accessory includes a frame and a portable medium-range RF transceiver. The frame is configured to detachably couple and electrically connect the accessory to a wireless personal communication device in a manner effective to receive electrical power from the wireless personal communication device. The portable medium-range RF transceiver is configured to communicate directly with an in-vehicle medium-range RF transceiver such that the wireless personal communication device can communicate directly with an in-vehicle telematics unit in a manner effective for the wireless personal communication device to display the vehicle data and control operation of the vehicle device.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a communication system in accordance with one embodiment; and

FIG. 2 is a perspective view of the wireless personal communication device and the wireless personal communication device accessory shown in FIG. 1 in accordance with one embodiment.

### DETAILED DESCRIPTION OF INVENTION

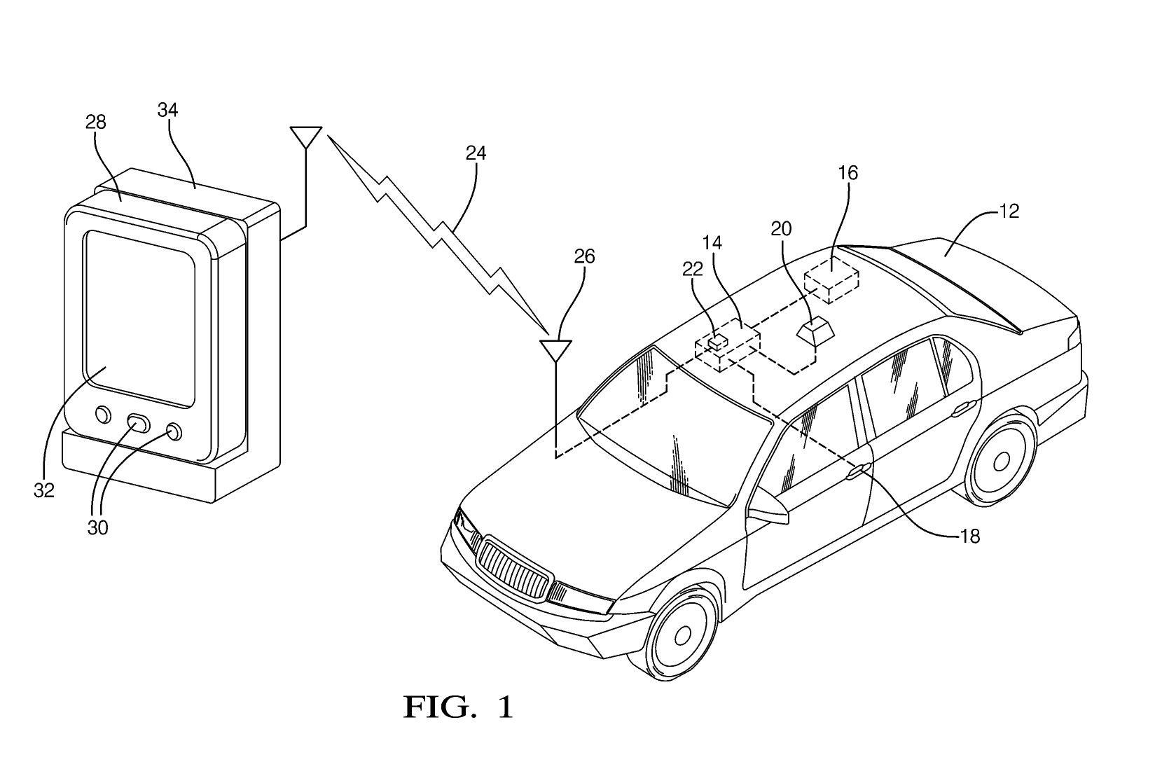

In accordance with an embodiment of a communication system 10, FIG. 1 illustrates a vehicle 12 equipped with an in-vehicle telematics unit 14, hereafter often telematics unit 14. The telematics unit 14 may be configured to determine vehicle data such as tire pressure or engine oil life by communicating with an engine control unit (ECU) 16. The telematics unit 14 may also be configured to control operation of a vehicle device such as a powered door lock 18 or a vehicle security camera 20. The telematics unit 14 may also be equipped with an in-vehicle medium-range RF transceiver 22, hereafter often vehicle transceiver 22. The vehicle transceiver 22 may be a RF receive only type device, or a RF transmit only type device. However, a vehicle transceiver having both RF receive and RF transmit capability is preferred to enable a number of features as will be apparent in the description below. As used herein, medium-range means that the RF transceiver broadcasts a RF signal 24 suitable for use at ranges greater than thirty (30) meters and has an effective range of about one thousand (1000) meters. Communication systems with effective ranges of less than one hundred (100) meters are specifically excluded from this definition as they are characterized to be short-range. The vehicle transceiver 22 is illustrated has having a vehicle antenna 26, however the illustration is for the purpose of explanation and not limitation, and so it should be appreciated that the antenna 26 may not be visible from outside the vehicle 12.

The communication system 10 may also include a wireless personal communication device 28, for example a cellular phone or a device commonly known as a smart phone capable of being programmed with various software applications for execution by the operator by pressing buttons 30 or pressing a touch sensitive screen 32 on the wireless personal communication device 28. In general, the wireless personal communication device 28 is carried by an operator (not shown) of the vehicle 12, and as will be explained in more detail below, may be used by the operator to communicate with the vehicle 12 while the operator is away from the vehicle 12. The communication system 10 may also include a communication device accessory 34, hereafter often accessory 34. In general, the accessory 34 is detachably coupled to the wireless personal communication device 28 so that the accessory can be readily detached and reattached to the wireless personal communication device 28. The accessory 34 is illustrated as having an antenna 36 for the purposes of explanation and not limitation, and so it is understood that the antenna 36 may not be visible from outside the accessory 34.

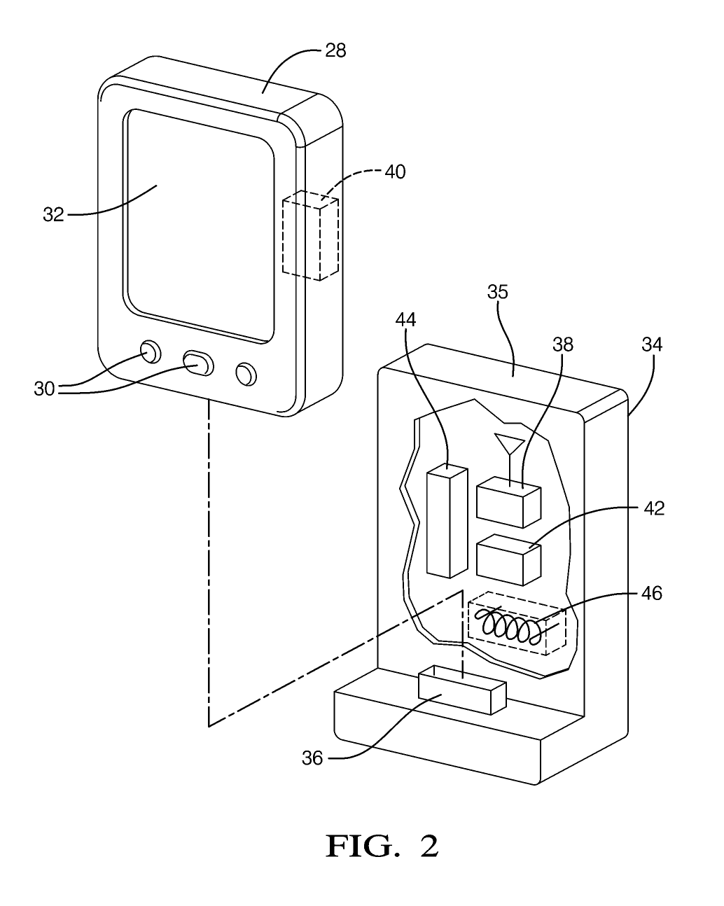

FIG. 2 illustrates a non-limiting example of the accessory 34 detached from the wireless personal communication device 28 for the purpose of explanation. The accessory 34 is generally defined by a frame 35 configured to be readily attached and detached to the wireless personal communication device 28. The frame 35 may include clips or tabs or other known means for making attaching and detaching the accessory 34 convenient. In general, the accessory 34 is electrically connected to the wireless personal communication device 28 so the accessory 34 can receive electrical power from the wireless personal communication device 28. In one embodiment, the accessory 34 may include a connector 36 that connects to a matching connector (not specifically shown) on the wireless personal communication device 28. Such a connector is generally configured to connect to a battery 40 within the wireless personal communication device 28 in order for the accessory 34 to draw electrical power from the battery 40.

The accessory 34 may be equipped with a portable medium-range RF transceiver 38, hereafter often portable transceiver 38, which is configured to communicate directly with the vehicle transceiver 22. The definition of medium-range given above with regard to vehicle transceiver 22 also applies to the portable transceiver 38. As used herein, communicate directly means that there is no other device or system facilitating communications between the vehicle transceiver 22 and the portable transceiver 38. As such, communications networks such as cell-phone networks and repeater stations are specifically excluded as they are examples of communication that is not direct communication. It will be appreciated that by providing direct communication, subscription fees normally associated with vehicle communication services such as On-Star and/or cellular phone services are avoided.

The wireless personal communication device 28 may be configured to communicate with the portable transmitter 38 so that an operator could transmit a command via the portable transmitter 38, or display a message or information received by the portable transceiver 38. The communication between the wireless personal communication device 28 and the portable transceiver 38 may be wireless communication, for example Bluetooth, or may be wired communication via the connector 36. As such, the accessory 34 may be electrically coupled to the wireless personal communication device 28 via a wired connection that provides an electrical power connection and a data connection between the accessory 34 and the wireless personal communication device 28. With such an arrangement, the wireless personal communication device 28 can communicate directly with the in-vehicle telematics unit 14 in a manner effective for the wireless personal communication device 28 to display vehicle data such as an image captured by the vehicle security camera 20, and/or control operation of a vehicle device such as the powered door lock 18.

When an vehicle operator uses a short-range communication device such as a key fob to operate a vehicle device such as the powered door lock 18, the operator can readily confirm that the powered door lock 18 operated either by hearing the sound of the powered door lock 18 actuating, or by a vehicle generated confirmation indication such as flashing lights on the vehicle or sounding a vehicle horn. However, if the accessory 34 is equipped with a medium-range transmitter or transceiver, the operator may transmit a signal to lock or unlock the vehicle doors while being located where the operator cannot observe that the powered door lock 18 actually operated. As such, it may be preferable for both the accessory 34 and telematics unit 14 to be equipped with two-way communications devices so that a confirmation signal can be sent from the vehicle to the wireless personal communication device 28 following the operator transmitting a command signal to the vehicle 12.

Continuing to refer to FIG. 2, the accessory 34 may also be equipped with a near field communications (NFC) device 42. The NFC device may be an autonomous device such as is used to initiate a financial transaction at a fuel pump. The NFC device may also be electronically coupled to the wireless personal communication device 28 so that the specific information transmitted by the NFC device can be customized as needed.

The accessory 34 may also include a secondary battery 44 to backup and/or supplement the battery 40 within the wireless personal communication device 28. The accessory 34 may also include a secondary charging means such as an inductive device 46 capable of generating a charging voltage that is applied to the battery 40 and/or the secondary battery 44 when the inductive device 46 is placed in or near an alternating magnetic field.

Accordingly, a communication system 10, a wireless personal communication device accessory 34 is provided. By equipping the communication system 10 with medium-range transceivers 22 and 38, the effective range for communication with the vehicle 12 is extended. Such extended range allows a vehicle operator to, for example, remotely start the vehicle 12 from a distance, e.g. within a workplace or shopping place, so that the vehicle interior has ample time to warm up before the operator arrives at the vehicle 12. Such a communication system 10 may also be used to verify that the vehicle is still where is was parked, remotely determine if the vehicle needs to be serviced, remotely download music or other entertainment data, or remotely view the area surrounding the vehicle for security or safety reasons. Since the operator likely already regularly charges the battery 40 within the wireless personal communication device 28, the problem of having to recharge or replace batteries in a medium range key fob, or equip the key fob with undesirably large batteries is overcome. Furthermore, by coupling the key fob functions to the wireless personal communication device 28, the operator only needs to carry one device instead of a separate smart phone and key fob.

While this invention has been described in terms of the preferred embodiments thereof, it is not intended to be so limited, but rather only to the extent set forth in the claims that follow.

We claim:

1. A communication system for communicating with a vehicle comprising:
an in-vehicle telematics unit configured to determine vehicle data and control operation of a vehicle device, said in-vehicle telematics unit equipped with an in-vehicle medium-range RF transceiver;
a wireless personal communication device carried by an operator of the vehicle; and
a communication device accessory detachably coupled and electrically connected to the wireless personal communication device in a manner effective to receive electrical power from the wireless personal communication device, said communication device accessory equipped with a portable medium-range RF transceiver configured to communicate directly with the in-vehicle medium-range RF transceiver such that the wireless personal communication device can communicate directly with the in-vehicle telematics unit in a manner effective for the wireless personal communication device to display the vehicle data and control operation of the vehicle device.

2. The system in accordance with claim 1, wherein the communication device accessory is electrically coupled to the wireless personal communication device via a wired connection that provides a power connection and a data connection between the communication device accessory and the wireless personal communication device.

3. The system in accordance with claim 1, wherein the communication device accessory further comprises a near field communications device.

4. The system in accordance with claim 3, wherein the near field communications device is electrically coupled to the wireless personal communication device.

5. The system in accordance with claim 1, wherein the communication device accessory further comprises a secondary battery.

6. The system in accordance with claim 1, wherein the communication device accessory further comprises a secondary charging means.

7. A wireless personal communication device accessory comprising:
a frame configured to detachably couple and electrically connect the accessory to a wireless personal communication device in a manner effective to receive electrical power from the wireless personal communication device;
a portable medium-range RF transceiver configured to communicate directly with an in-vehicle medium-range RF transceiver such that the wireless personal communication device can communicate directly with an in-vehicle telematics unit in a manner effective for the wireless personal communication device to display the vehicle data and control operation of the vehicle device.

8. The communication device accessory in accordance with claim 7, wherein the communication device accessory is electrically coupled to the wireless personal communication device via a wired connection that provides a power connection and a data connection between the communication device accessory and the wireless personal communication device.

9. The communication device accessory in accordance with claim 7, wherein the communication device accessory further comprises a near field communications device.

10. The communication device accessory in accordance with claim 9, wherein the near field communications device is electrically coupled to the wireless personal communication device.

11. The communication device accessory in accordance with claim 7, wherein the communication device accessory further comprises a secondary battery.

12. The communication device accessory in accordance with claim 7, wherein the communication device accessory is further configured to cooperate with a secondary charging means.
